(19) United States
(12) Patent Application Publication
(10) Pub. No.: US 2024/0267278 A1
(43) Pub. Date: Aug. 8, 2024

(54) CONTRACT MANAGEMENT METHOD, APPARATUS, AND SYSTEM

(71) Applicant: HUAWEI TECHNOLOGIES CO., LTD., Shenzhen (CN)

(72) Inventors: Wei TAN, Shenzhen (CN); Chenchen YANG, Ottawa (CA); Fei LIU, Singapore (SG); Donghui WANG, Beijing (CN)

(21) Appl. No.: 18/641,025

(22) Filed: Apr. 19, 2024

Related U.S. Application Data
(63) Continuation of application No. PCT/CN2022/124092, filed on Oct. 9, 2022.

(30) Foreign Application Priority Data
Oct. 22, 2021 (CN) 202111230873.8

(51) Int. Cl. H04L 41/04; H04L 9/00

(52) U.S. Cl. CPC H04L 41/04; H04L 9/50

(57) ABSTRACT

Embodiments of the present invention disclose a contract management method, apparatus, and system. The method includes: A communication device sends a registration request to a management network element. The registration request includes service request information, and the service request information indicates a specific service. After receiving the registration request from the communication device, the management network element determines a first smart contract based on the service request information in the registration request. Then, the management network element sends the first smart contract to the communication device. According to embodiments of the present invention, service waiting time of a user may be reduced.

### CROSS-REFERENCE TO RELATED APPLICATIONS

This application is a continuation of International Application No. PCT/CN2022/124092, filed on Oct. 9, 2022, which claims priority to Chinese Patent Application No. 202111230873.8, filed on Oct. 22, 2021. The disclosures of the aforementioned applications are hereby incorporated by reference in their entireties.

### TECHNICAL FIELD

This application relates to the field of communication technologies, and in particular, to a contract management method, apparatus, and system.

### BACKGROUND

A blockchain is a new application mode integrating computer technologies such as distributed data storage, a consensus mechanism, and an encryption algorithm. The blockchain is mainly used to sort data in time sequence and encrypt the data into a ledger, so that the ledger cannot be tampered with or forged. In addition, the data may be verified, stored, and updated. As an advanced distributed basic architecture, the blockchain may further be used for data encryption transmission, node identification, and secure access.

In a blockchain system, a smart contract defines transaction logic for controlling a life cycle of a business object included in a world state. The smart contract may be code that may be understood and executed by each node in the blockchain. Any logic may be executed, and a result may be obtained.

Due to immutability and authenticity of the blockchain and convenience of the smart contract, a blockchain technology may be introduced into a communication network, to resolve a mutual trust problem between devices (for example, base stations, mobile phone terminals, or the like) in the communication network. In addition, various types of businesses may be processed according to the smart contract, to provide services in different business scenarios for a user. However, how to efficiently manage the smart contract and reduce service waiting time of the user is a problem that a technical person is concerned about.

### SUMMARY

Embodiments of the present invention disclose a contract management method, apparatus, and system, to reduce service waiting time of a user.

According to a first aspect, a contract management method is disclosed. The contract management method may be applied to a management network element or a module (for example, a chip) in a management network element. An example in which the method is applied to the management network element is used for description below. The contract management method may include: A management network element receives a registration request from a communication device, where the registration request includes service request information. The management network element determines a first smart contract based on the service request information. The management network element sends the first smart contract to the communication device.

In the foregoing embodiment, the management network element may receive the registration request from the communication device. The registration request includes the service request information, namely, business information. In addition, the management network element may locally store a smart contract. The smart contract is one-to-one correspondence with a service. In other words, one service corresponds to one smart contract, and a corresponding service (namely, a corresponding business) may be obtained according to a smart contract corresponding to the service. Therefore, the management network element may locally find, based on the service request information, the first smart contract corresponding to the service request information, that is, determine the first smart contract. Then, the management network element may send the first smart contract to the communication device. It can be learned that after receiving the registration request of the communication device, the management network element may send the first smart contract to the communication device, to deploy the smart contract in advance. Then, when a user needs to obtain a service corresponding to the first smart contract, the first smart contract may be directly used via the communication device, so that service waiting time of the user may be reduced.

In some embodiments, the method further includes: compiling the first smart contract, to obtain a first compilation result; and that the management network element sends the first smart contract to the communication device includes: sending the first smart contract and the first compilation result to the communication device.

In the foregoing embodiments, communication devices have different compilation capabilities. To be specific, some communication devices may not have compilation capabilities, and some communication devices may have weak compilation capabilities. High time costs are needed for compiling the first smart contract. Therefore, the management network element may compile the first smart contract, for example, obtain machine code of the first smart contract through compilation, that is, obtain the first compilation result. Then, the management network element may send the first smart contract and the first compilation result to the communication device. Then, when the user needs to obtain the service corresponding to the first smart contract, the first smart contract may be directly used, and the first compilation result is executed. It can be learned that the management network element compiles the first smart contract in a unified manner, so that compilation costs of the communication device may be reduced, and compilation time of the communication device may be saved.

In some embodiments, the method further includes: determining a group identifier ID based on the service request information, where the group ID identifies a first blockchain, and the communication device is a node in the first blockchain; and sending the group ID to the communication device.

In the foregoing embodiments, the management network element may allocate a group ID to the communication device based on the service request information, that is, determine the group ID. In other words, the management network element may add the communication device to the first blockchain (the communication device becomes a node in the first blockchain), and the first blockchain is a blockchain identified by the group ID. Then, the management network element may send the group ID to the communication device. It can be learned that the management network element may group the communication device into different groups based on different services requested by the communication device, in other words, add the communication device to different blockchains. This helps the management network element perform management. In addition, different groups (blockchains) may be dedicated to processing one type of transaction. In other words, only one type of service (such as a charging service or a voice service) is provided. Therefore, a blockchain architecture of an entire contract management system is simple. Only a single smart contract may be deployed on each blockchain, to improve contract management efficiency.

In some embodiments, the method further includes: receiving key-value pair information from the communication device, where the key-value pair information is information about a key-value pair corresponding to the first smart contract; and performing consensus on the key-value pair information.

In the foregoing embodiments, the management network element may receive the key-value pair information from the communication device, and then the management network element may perform consensus on the key-value pair information (in other words, verify the first smart contract). After the consensus is reached (in other words, an agreement on the first smart contract is reached), when the user needs to obtain the service corresponding to the first smart contract, the first smart contract may be directly used via the communication device. It can be learned that the management network element performs consensus on the key-value pair information, to ensure that the management network element and the communication device agree on the first smart contract. This helps the communication device subsequently obtain the corresponding service according to the first smart contract.

In some embodiments, the first smart contract includes field information, and the field information includes change information. The method further includes: receiving an update request from the communication device, where the update request includes update information and information about the first smart contract, and the update information is used to update the change information; compiling the first smart contract based on the update information, to obtain a second compilation result; and sending the second compilation result to the communication device.

In the foregoing embodiments, the first smart contract may declare only a field (namely, the field information) of the smart contract, and leave a value (namely, the change information) of the field null. The management network element may receive the update request from the communication device and determine, based on the information that is about the first smart contract and that is included in the update request, the first smart contract that needs to be updated. The management network element then may update a value of a field (for example, fill the value of the field) based on the update information. The management network element may compile updated first smart contract, to obtain the second compilation result; and then send the second compilation result to the communication device. In this way, the user can directly use the updated first smart contract via the communication device, to reduce the compilation costs of the communication device.

According to a second aspect, a contract management method is disclosed. The contract management method may be applied to a communication device or a module (for example, a chip) in a communication device. An example in which the method is applied to the communication device is used for description below. The contract management method may include: A communication device sends a registration request to a management network element, where the registration request includes service request information. The communication device receives a first smart contract from the management network element.

In the foregoing embodiment, the communication device may send the registration request to the management network element, where the registration request includes the service request information, to obtain a smart contract of a corresponding service from the management network element. Then, the communication device may receive the first smart contract from the management network element. It can be learned that the communication device may send the registration request to the management network element, to obtain the first smart contract, and locally store the first smart contract. Then, when a user needs to obtain a service corresponding to the first smart contract, the first smart contract may be directly used via the communication device, so that service waiting time of the user may be reduced.

With reference to some embodiments of the second aspect, in some embodiments, that the communication device receives a first smart contract from the management network element includes: receiving the first smart contract and a first compilation result from the management network element.

In the foregoing embodiments, after sending the registration request to the management network element, the communication device may receive the first smart contract and the first compilation result from the management network element. Then, when the user needs to obtain the service corresponding to the first smart contract, the first smart contract may be directly used, and the first compilation result is executed. In this way, a case in which the communication device performs compilation (for example, compiling the first smart contract to obtain corresponding machine code) in avoided. This may save compilation time of the communication device and reduce the service waiting time of the user.

With reference to some embodiments of the second aspect, in some embodiments, the method further includes: receiving a group identifier ID from the management network element, where the group ID identifies a first blockchain, and the communication device is a node in the first blockchain.

In the foregoing embodiments, the communication device sends the registration request to the management network element, and may join the first blockchain to become one node in the first blockchain. In addition, the communication device may receive the group ID from the management network element. This indicates that the communication device joins a corresponding group (blockchain). Therefore, it may be ensured that the user can obtain the corresponding service when using the first smart contract via the communication device.

With reference to some embodiments of the second aspect, in some embodiments, the method further includes: determining a key-value pair corresponding to the first smart contract, to obtain key-value pair information; and sending the key-value pair information to the management network element.

In the foregoing embodiments, after receiving the first smart contract, the communication device may determine the key-value pair of the first smart contract, and store the first smart contract in a manner of the key-value pair. Then, the communication device may send the key-value pair information to the management network element, so that the management network element performs consensus on the key-value pair information. This ensures that the management network element agrees on the first smart contract. After the management network element agrees on the first smart contract, the communication device may normally use the first smart contract. Therefore, that the communication device sends the key-value pair information to the management network element may ensure that the communication device can subsequently obtain the corresponding service according to the first smart contract.

With reference to some embodiments of the second aspect, in some embodiments, the first smart contract includes field information, the field information includes change information. The method further includes: sending an update request to the management network element, where the update request includes update information and information about the first smart contract, and the update information is used to update the change information; and receiving a second compilation result from the management network element.

In the foregoing embodiments, the first smart contract may declare only a field (namely, the field information) of the smart contract, and leave a value (namely, the change information) of the field null. When there is a service application (when a transaction is generated), the communication device may send the update request to the management network element, and update the change information of the first smart contract based on the update information. The update request may include only the update information and the information about the first smart contract, that is, changed information in the change information of the first smart contract, and does not need to include all content of the first smart contract. Therefore, transmission resources occupied by the communication device for sending the update request may be reduced. In addition, the communication device may further receive the second compilation result from the management network element, that is, a compilation result of an updated first smart contract. Then, the communication device may directly execute the second compilation result to obtain a corresponding service, and does not need to perform compilation, so that compilation time is reduced.

According to a third aspect, a contract management apparatus is disclosed. The contract management apparatus may be a management network element or a module (for example, a chip) in a management network element. The contract management apparatus may include: a receiving unit, configured to receive a registration request from a communication device, where the registration request includes service request information; a determining unit, configured to determine a first smart contract based on the service request information; and a sending unit, configured to send the first smart contract to the communication device.

In a possible implementation, the contract management apparatus may further include a first compilation unit, configured to compile the first smart contract, to obtain a first compilation result. The sending unit is specifically configured to send the first smart contract and the first compilation result to the communication device.

In a possible implementation, the determining unit is further configured to determine a group identifier ID based on the service request information, where the group ID identifies a first blockchain, and the communication device is a node in the first blockchain; and the sending unit is further configured to send the group ID to the communication device.

In a possible implementation, the receiving unit is further configured to receive key-value pair information from the communication device, where the key-value pair information is information about a key-value pair corresponding to the first smart contract. The contract management apparatus may further include a consensus unit, configured to perform consensus on the key-value pair information.

In a possible implementation, the first smart contract includes field information, and the field information includes change information. The receiving unit is further configured to receive an update request from the communication device, where the update request includes update information and information about the first smart contract, and the update information is used to update the change information. The contract management apparatus may further include a second compilation unit, configured to compile the first smart contract based on the update information, to obtain a second compilation result. The sending unit is further configured to send the second compilation result to the communication device.

According to a fourth aspect, a contract management apparatus is disclosed. The contract management apparatus may be a communication device or a module (for example, a chip) in a communication device. The contract management apparatus may include: a sending unit, configured to send, by a communication device, a registration request to a management network element, where the registration request includes service request information; and a receiving unit, configured to receive a first smart contract from the management network element.

In a possible implementation, the receiving unit is specifically configured to receive the first smart contract and a first compilation result from the management network element.

In a possible implementation, the receiving unit is further configured to receive a group identifier ID from the management network element, where the group ID identifies a first blockchain, and the communication device is a node in the first blockchain.

In a possible implementation, the contract management apparatus may further include: a determining unit, configured to determine a key-value pair corresponding to the first smart contract, to obtain key-value pair information. The sending unit is further configured to send the key-value pair information to the management network element.

In a possible implementation, the first smart contract includes field information, and the field information includes change information. The sending unit is further configured to send an update request to the management network element, where the update request includes update information and information about the first smart contract, and the update information is used to update the change information. The receiving unit is further configured to receive a second compilation result from the management network element.

According to a fifth aspect, a contract management apparatus is disclosed. The contract management apparatus may be a management network element or a module (for example, a chip) in a management network element. The contract management apparatus may include a processor, a storage, and a transceiver. The transceiver is configured to receive information from a contract management apparatus other than the contract management apparatus, and output information to the contract management apparatus other than the contract management apparatus. When the processor executes a computer program stored in the storage, the processor is enabled to perform the contract management method disclosed according to the first aspect or any implementation of the first aspect.

According to a sixth aspect, a contract management apparatus is disclosed. The contract management apparatus may be a communication device or a module (for example, a chip) in a communication device. The contract management apparatus may include a processor, a storage, and a transceiver. The transceiver is configured to receive information from a contract management apparatus other than the contract management apparatus, and output information to the contract management apparatus other than the contract management apparatus. When the processor executes a computer program stored in the storage, the processor is enabled to perform the contract management method disclosed according to the second aspect or any implementation of the second aspect.

According to a seventh aspect, a contract management system is disclosed. The contract management system includes the contract management apparatus according to the fifth aspect and the contract management apparatus according to the sixth aspect.

According to an eighth aspect, a computer-readable storage medium is disclosed. The computer-readable storage medium stores a computer program or computer instructions. When the computer program is run or the computer instructions are run, the contract management method disclosed according to the foregoing aspects is implemented.

According to a ninth aspect, a chip is disclosed. The chip includes a processor, configured to execute a program stored in a storage. When the program is executed, the chip is enabled to perform the foregoing method.

In a possible implementation, the storage is located outside the chip.

According to a tenth aspect, a computer program product is disclosed. The computer program product includes computer program code. When the computer program code is run, the foregoing contract management method is performed.

It may be understood that, the contract management apparatus according to the third aspect, the contract management apparatus according to the fourth aspect, the contract management apparatus according to the fifth aspect, the contract management apparatus according to the sixth aspect, the computer-readable storage medium according to the eighth aspect, the chip according to the ninth aspect, and the computer program product according to the tenth aspect are all configured to perform the method according to the first aspect and any possible implementation in the first aspect, or according to the second aspect and any possible implementation in the second aspect in this application. Therefore, for beneficial effects that can be achieved, refer to the beneficial effects in the corresponding methods. Details are not described herein again.

### BRIEF DESCRIPTION OF DRAWINGS

To describe technical solutions in embodiments of the present invention more clearly, the following briefly describes accompanying drawings needed for describing embodiments. It is clear that, the accompanying drawings in the following descriptions only show some embodiments of the present invention, and a person of ordinary skill in the art may still derive other drawings from these accompanying drawings without creative efforts.

FIG. 1 is a schematic diagram of a network architecture according to an embodiment of the present invention;

FIG. 2 is a schematic diagram of a blockchain architecture according to an embodiment of the present invention;

FIG. 3 is a schematic diagram of deployment of a smart contract according to an embodiment of the present invention;

FIG. 4 is a schematic flowchart of a contract management method according to an embodiment of the present invention;

FIG. 5 is a schematic diagram of a first smart contract according to an embodiment of the present invention;

FIG. 6 is a schematic diagram of use of a first smart contract according to an embodiment of the present invention;

FIG. 7 is a schematic diagram of a structure of a contract management apparatus according to an embodiment of the present invention;

FIG. 8 is a schematic diagram of a structure of another contract management apparatus according to an embodiment of the present invention;

FIG. 9 is a schematic diagram of a structure of still another contract management apparatus according to an embodiment of the present invention;

FIG. 10 is a schematic diagram of a structure of yet another contract management apparatus according to an embodiment of the present invention; and

FIG. 11 is a schematic diagram of a structure of a contract management system according to an embodiment of the present invention.

### DESCRIPTION OF EMBODIMENTS

Embodiments of the present invention disclose a contract management method and apparatus, to reduce service waiting time of a user. The following clearly describes the technical solutions in embodiments of this application with reference to the accompanying drawings in embodiments of this application.

It is clear that, described embodiments are merely some but not all of embodiments of this application. An “embodiment” mentioned in this specification means that a specific feature, structure, or characteristic described with reference to embodiments may be included in at least one embodiment of embodiments of this application. The phrase shown in various locations in the specification does not necessarily refer to a same embodiment, and is not an independent or optional embodiment exclusive from another embodiment. It may be understood explicitly and implicitly by a person skilled in the art that embodiments described in this specification may be combined with another embodiment. All other embodiments obtained by a person of ordinary skill in the art based on embodiments of this application without creative efforts shall fall within the protection scope of this application.

In the specification, claims, and accompanying drawings of this application, the terms “first”, “second”, “third”, and the like are intended to distinguish between different objects but do not indicate a specific order. In addition, terms such as “include” and “have” and any other variants thereof are intended to cover a non-exclusive inclusion. For example, a series of steps or units are included, or optionally an unlisted step or unit is included, or optionally another step or unit inherent to the process, the method, the product, or the device is further included.

The accompanying drawings show only a part rather than all content related to this application. Before example embodiments are discussed in more detail, it should be mentioned that some example embodiments are described as processing or methods depicted as flowcharts. Although the flowcharts describe the operations (or steps) as sequential processing, many of these operations can be implemented in parallel, concurrently, or simultaneously. In addition, the sequence of the operations may be rearranged. The processing may be terminated when the operations are completed, but may further have additional steps that are not included in the accompanying drawings. The processing may correspond to a method, a function, a procedure, a subroutine, a subprogram, or the like.

Terms such as “part”, “module”, “system” and “unit” used in this specification are used to indicate computer-related entities, hardware, firmware, combinations of hardware and software, software, or software being executed. For example, a unit may be, but is not limited to, a process that runs on a processor, a processor, an object, an executable file, an execution thread, a program, and/or distributed between two or more computers. In addition, these units may be executed from various computer-readable media that store various data structures. The units may communicate, by using a local and/or remote process and based on, for example, a signal having one or more data packets (for example, data from a second unit interacting with another unit in a local system, a distributed system, and/or a network such as the internet interacting with another system by using the signal).

To better understand embodiments of the present invention, the following first describes conventional technologies in embodiments of the present invention.

In the past few decades, a wireless communication system has undergone technical evolution from a 1st generation analog communication to a 5th generation (5th generation, 5G) mobile communication technology new radio (new radio, NR). Currently, research on a 6th generation (6th generation, 6G) mobile communication technology network is also started. In a 6G network, various networks such as space-air-land-sea networks may be included in space. Actual network carriers may include a medium- and low-altitude platform network such as a satellite network and an uncrewed aerial vehicle, a cellular network, an internet of vehicles, an internet of things (internet of things, IoT), a water surface network, an underwater network, and the like. In addition, an entire communication network includes various communication devices. In other words, the entire communication network includes various network participants, such as a base station, a mobile phone terminal, an uncrewed aerial vehicle, a smart car, and various IoT devices. In the 6G era, various terminal devices have more powerful functions. For example, computing, storage, and communication capabilities of the smart car are greatly improved. Therefore, the terminal devices may be applicable to more application scenarios such as a blockchain.

The 6G communication network may include a plurality of distributed networks, and is not limited to a feature of a single communication operator. The entire network may include a large quantity of devices from different operators or manufacturers. Consequently, effective cooperation cannot be performed between the communication devices (for example, an access device (such as a mobile phone terminal) and an access point (such as a base station or an uncrewed aerial vehicle platform) cannot trust each other and work together). Therefore, the 6G communication network needs a multi-party mutual trust mechanism and platform, to resolve a mutual trust problem between the communication devices in the communication network.

In a blockchain technology, data may be generated and stored in a unit of a block (block), and connected into a chain (chain) data structure in time sequence. All nodes of a blockchain jointly participate in data verification, storage, and maintenance of a blockchain system. For a newly created block, consensus is needed to be reached by a blockchain node. The new block is broadcast to all nodes, to implement synchronization in the entire network. After this, it cannot be modified or deleted. A blockchain type may be classified into a public chain, a consortium chain, and a private chain. A chain structure may be further classified into a main chain, a main chain and a side chain, a plurality of parallel chains, and the like. Different types and structures of blockchains may use different consensus algorithms, incentive mechanisms, and smart contract usage methods. Therefore, the blockchain may flexibly process various types of businesses and is applicable to different scenarios. In the blockchain system, a smart contract may be understood as a presentation form of a rule (for example, jointly processing a business) agreed upon by contract participants, and includes rights and obligations approved of by each participant. The smart contract may also be understood as a computerized transaction protocol, and defines transaction logic for controlling a life cycle of a business object included in a world state.

In the future, the 6G network will face ultra-large-scale access. In a distributed networking mode, different communication devices in the communication network need to quickly implement mutual trust, to ensure normal operating of the entire communication network and provide normal services. Therefore, the communication system needs to record network behavior and operating data, check operating data of each communication device, and the like, so that the operating data may be traced later. This improves security of the entire communication system.

Due to immutability and authenticity of the blockchain and convenience of the smart contract, the blockchain technology may be introduced into the communication network, to resolve a mutual trust problem between the communication devices (for example, base stations, mobile phone terminals, or the like) in the communication network. In addition, the network behavior and various data in the network can be traced and queried.

Currently, one blockchain has a plurality of different smart contracts, and most of the smart contracts are complex. These smart contracts are defined in advance to meet different business scenarios. Because a plurality of complex smart contracts are written onto one blockchain, storage costs of each node in the blockchain are high. When one service is started or changed, a blockchain node writes content and a functional function of a smart contract, and sends the content and the function to each blockchain node. Each node stores, compiles, and executes a full contract. In this case, transmission of the contract occupies a large quantity of resources, and storage of the full contract by the node occupies a large quantity of storage resources. In addition, because an immediate execution upon sending mode is used, service waiting time of a user is long.

In a wireless network, available resources are limited, and these resources need to meet large-scale device access and service requirements. In addition, service waiting time of a user is also an important factor that affects quality of service (quality of service, QoS). Therefore, how to efficiently manage a smart contract, save transmission resources, reduce node storage costs, and reduce service waiting time of a user is a problem that a technical person is concerned about.

To better understand embodiments of the present invention, the following first describes a network architecture in embodiments of the present invention.

FIG. 1 is a schematic diagram of a network architecture according to an embodiment of the present invention. As shown in FIG. 1, the network architecture may include a communication device and a management network element (CONET management). The communication device may include one or more communication devices (FIG. 1 shows two communication devices), for example, a communication device 10a (a smartphone) and a communication device 10b (a notebook computer) shown in FIG. 1. The management network element may include one or more management network elements (FIG. 1 shows one management network elements). The management network element may also be referred to as a management device.

As shown in FIG. 1, the communication device 10a, the communication device 10b, and the like may communicate with the management network element, so that data transmission may be performed between the communication devices and the management network element.

It should be noted that the network architecture shown in FIG. 1 is not limited to including only the communication device and the management network element shown in FIG. 1.

It should be understood that the network architecture shown in FIG. 1 is merely an example for description, and does not constitute a limitation on the network architecture.

It should be understood that the communication device may be a terminal device, where the terminal device may be referred to as user equipment (user equipment, UE), a mobile station (mobile station, MS), a mobile terminal (mobile terminal, MT), or the like, and is a device that provides data connectivity for a user. The terminal device may be a handheld terminal, a notebook computer, a wearable device (such as a smartwatch, a smart band, or a pedometer), a vehicle-mounted device (such as an automobile or a high-speed train), a virtual reality (virtual reality, VR) device, an augmented reality (augmented reality, AR) device, a wireless terminal in industrial control (industrial control), and a smart home device (such as a refrigerator, a television, an air conditioner, or an electricity meter), an intelligent robot, a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), a flying device (such as an intelligent robot or an uncrewed aerial vehicle), or another device that can access a network.

The communication device may alternatively be a radio access network device. The radio access network device is an apparatus that is deployed in a radio access network to provide a wireless communication function for the terminal device. The radio access network (radio access network, RAN) device may include base stations in various forms, for example, a macro base station, a micro base station (which is also referred to as a small cell), a relay station, or an access point (access point, AP). In systems using different radio access technologies, names of radio access network devices may be different, for example, a base transceiver station (base transceiver station, BTS) in a global system for mobile communication (global system for mobile communication, GSM) or a code division multiple access (code division multiple access, CDMA) network, an NB (NodeB) in wideband code division multiple access (wideband code division multiple access, WCDMA), or an eNB or eNodeB (evolved NodeB) in long term evolution (long term evolution, LTE). The radio access network device may alternatively be a radio controller in a cloud radio access network (cloud radio access network, CRAN) scenario. The radio access network device may alternatively be a base station device in a future network (such as 6G) or a radio access network device in a future evolved public land mobile network (public land mobile network, PLMN). The radio access network device may alternatively be a wearable device or a vehicle-mounted device. The radio access network device may alternatively be a transmission and reception point (transmission and reception point, TRP) or the like.

The communication device may alternatively be another network participant in a communication network. For example, the communication device may be various network units, including an uncrewed aerial vehicle, a smart car, and the like.

The management network element may be a computer device, and the computer device includes but is not limited to a core network device or a server. The method provided in embodiments of the present invention may be performed by the computer device.

In this embodiment of the present invention, a management network element that is, a trusted network (confederation of multi players for management and control of future wireless networks, CONET) managing device (management) is newly added to an existing communication system. The management network element may manage a blockchain, a blockchain member (node), a smart contract, and the like in the communication network. An entire blockchain system of the CONET may include one main blockchain (main chain) and a plurality of sub-blockchains (sub chain). The sub-blockchain may be a side chain of the main blockchain. Therefore, based on an actual business requirement, a function of the entire blockchain system may be extended by adding a side chain to the main chain. For example, data analysis and management services need to be provided for the user based on an existing service. The services can be implemented by adding the side chain.

In the CONET, each blockchain is dedicated to processing one type of transaction. In other words, only one type of service (such as a charging service or a voice service) is provided. Therefore, a blockchain architecture of the entire communication system is simple. Only a single smart contract may be deployed on each blockchain, to facilitate management. In addition, the present invention further provides an efficient smart contract management method. Each blockchain may have one smart contract, to provide a specific service. The smart contract declares only a field of the smart contract, and leaves a value of the field null. The smart contract in the present invention may also be referred to as a root contract. In addition, the management network element may first compile the root contract in advance, including compiling a functional function and the like in the root contract, and distribute a compilation result (such as machine code) and the root contract to each node in a blockchain network. Then, the communication device only needs to fill a changed part of content of the smart contract based on the root contract each time user service application is performed. This helps obtain a corresponding service. In addition, on each blockchain in the CONET, only the changed part of the content of the smart contract is stored in the blockchain after each blockchain node reaches a consensus. Therefore, storage costs of each node in the blockchain can be reduced.

It can be learned that in this embodiment of the present invention, the management network element may deliver the root contract in advance, in other words, deploy the root contract on each blockchain node in advance. Then, the communication device only needs to directly fill a corresponding field for use each time user service application is performed. Therefore, service waiting time of the user may be reduced. In addition, the management network element may further deliver a compilation result to each blockchain node, so that each node can directly use the compilation result. This avoids that each node in the blockchain network independently compiles the smart contract, and reduces compilation costs of each node.

The communication device 10a and the management network element are used as an example to briefly describe deployment of a first smart contract and an interaction procedure between the communication device 10a and the management network element when the first smart contract is used in this application. First, when the user needs a service, a service request (that is, a business request) may be sent to the management network element via the communication device. The management network element may receive a registration request (where the registration request includes service request information) sent by the communication device 10a. The service request information indicates the service needed by the user. After receiving the registration request, the management network element may determine, based on the service request information included in the registration request, a first smart contract corresponding to the service request (where the first smart contract includes field information, the field information includes change information, and the field information indicates a field of the first smart contract). The management network element may compile the first smart contract, including compiling a functional function and the like in the first smart contract, to obtain a first compilation result (for example, machine code). The management network element may send the first smart contract and the first compilation result to the communication device 10a. The first smart contract and the first compilation result that are sent by the management network element may be transmitted to the communication device 10a based on radio resources. After the communication device 10a receives the first smart contract and the first compilation result that are sent by the management network element, when the user needs to obtain a service corresponding to the first smart contract, the first smart contract may be used. A value of the field of the first smart contract may be updated, and the first compilation result sent by the management network element may be directly executed for running the first smart contract, to obtain the corresponding service.

After the service is completed and the service result is obtained, the communication device 10a may generate a new block based on the service result, and may generate a new block based on a changed part of content of the first smart contract. Then, the communication device 10a may send, based on a node identifier, the newly generated block to the management network element, and may send the newly generated block to each blockchain node in a blockchain to which the first smart contract belongs. The management network element and/or each blockchain node in the blockchain to which the first smart contract belongs verify (that is, perform consensus) the newly generated block. After the verification is completed, the newly generated block is added to the blockchain in which the block is stored (that is, after the consensus is reached, the service result and the changed part of the contract content are stored in the blockchain). Each node in the blockchain network may have a node identifier corresponding to the node, and each node in the blockchain network may store a node identifier of another node in the blockchain network, so that a generated block is subsequently sent to the another node in the blockchain network based on the node identifier of the another node. In this way, data stored on all the nodes in the blockchain network is consistent.

It may be understood that, information sent by the communication device to the management network element and information sent by the management network element to the communication device may be transmitted based on radio resources (for example, time-frequency resources).

To better understand embodiments of the present invention, the following first describes a blockchain architecture in embodiments of the present invention.

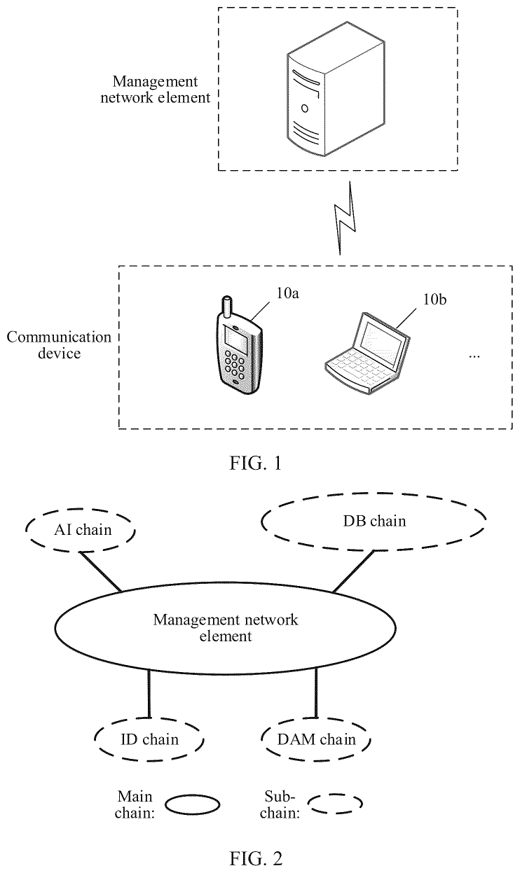

An entire blockchain system of the CONET may include one main blockchain (main chain) and a plurality of sub-blockchains (sub-chain). The sub-blockchain may be a side chain of the main blockchain. Each sub-blockchain may provide one type of service to resolve a corresponding problem. In addition, more services may be provided by adding a side chain to the main chain, to meet various actual requirements of the user. FIG. 2 is a schematic diagram of a blockchain architecture according to an embodiment of the present invention. As shown in FIG. 2, the blockchain architecture may include one main chain and a plurality of sub-chains (side-chains).

The main chain is a cornerstone of the entire blockchain system, and mainly provides a most basic service (for example, a data storage service) for the entire blockchain system. In addition, the main chain may further provide support for different side chains (for example, help side chains implement consensus), and the like. The main chain and the side chain may collaborate with each other. A function of the main chain may be added by adding the side chain, so that the main chain may be applicable to more scenarios. In addition, each blockchain in the CONET may have only one root (Root) contract, to provide a specific service. This helps a management network element perform management. However, one smart contract is used to invoke another smart contract, so that different smart contracts may be more flexibly used. This helps resolve a more complex problem.

In the blockchain architecture, a management network element (CONET management) is responsible for managing the entire blockchain system. Specifically, the management network element may be responsible for managing a member in a group, including receiving a registration request (where the registration request includes service request information) of a communication device. In addition, the management network element may further allocate the communication device to a corresponding group based on the service request information, in other words, add the communication device to a corresponding blockchain. The communication device becomes one node in the blockchain and one member in the group. Each group may have a group (group) identifier (identity identifier, ID). The group ID may identify a blockchain. Each communication device may also have an ID used to identify the communication device. It may be understood that the CONET may include a plurality of blockchains. Correspondingly, the communication device may be a node in the plurality of blockchains, in other words, the communication device may belong to a plurality of groups. The management network element may further be responsible for managing a parameter of each group, for example, a blockchain type, a blockchain structure, and a root contract of each group. In addition, the management network element may further monitor a situation (for example, an online state or an offline state) of each member, record and store behavior (for example, sent data information and received data information) of each member, and the like.

As shown in FIG. 2, the CONET may include an artificial intelligence (artificial intelligence, AI) side chain (chain), a database (data base, DB) side chain, an identifier side chain, a data analysis management (data analysis management, DAM) side chain, and the like. The AI chain may provide a service such as AI model training, and provide training resources (such as memory resources and computing resources) for a user. The DB chain provides database-related functions for the user, such as data storage, data reading, data backup, and the like. The ID chain may be responsible for ID management of each group and a member in the group in the CONET, including adding and deleting a member in each group. The DAM chain may provide services such as data analysis and management. For example, the DAM chain may provide big data analysis for the user, and may provide feasibility suggestions for the user based on an analysis result. It may be understood that the foregoing services may be implemented according to a smart contract in a blockchain. It should be understood that the blockchain architecture shown in FIG. 2 is merely an example for description, and does not constitute a limitation on the blockchain architecture.

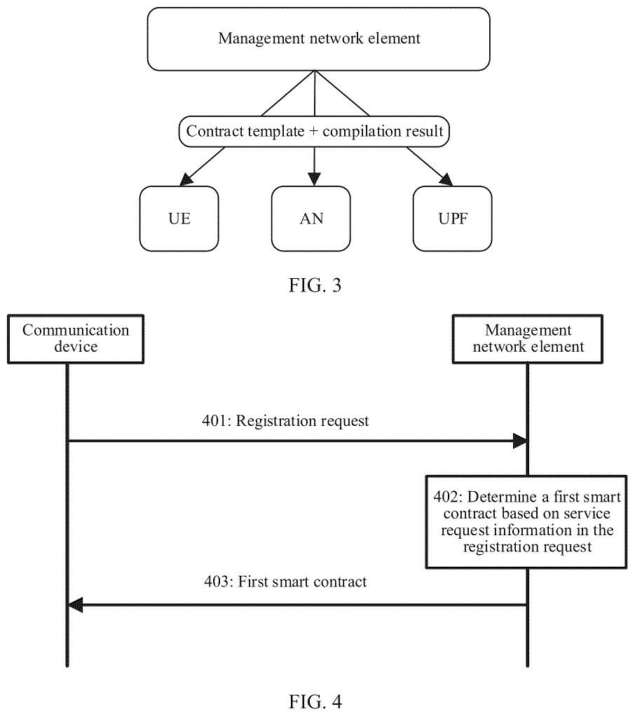

FIG. 3 is a schematic diagram of deployment of a smart contract according to an embodiment of the present invention. As shown in FIG. 3, after receiving a registration request of a communication device, a management network element may determine a contract template based on service request information included in the registration request. The contract template is a first smart contract (root contract). Then, the management network element may compile the first smart contract, to obtain a compilation result. The management network element may send the first smart contract and the compilation result to the communication device, so that a user can directly use the first smart contract during service application. As shown in FIG. 3, the communication device may be UE, a device in an access network (access network, AN), or a device in a user plane function (user plane function, UPF). It should be understood that the deployment of the smart contract shown in FIG. 3 is merely an example for description, and does not constitute a limitation on the deployment of the smart contract.

Based on the foregoing network architecture, FIG. 4 is a schematic flowchart of a contract management method according to an embodiment of the present invention. As shown in FIG. 4, the contract management method may include the following steps.

401: A communication device sends a registration request to a management network element, where the registration request includes service request information.

Correspondingly, the management network element may receive the registration request from the communication device.

Each blockchain in a CONET may have only one root (Root) contract. The root contract is used to provide a specific service. A user may send the registration request to the management network element via the communication device, to obtain a first smart contract, and may further obtain a corresponding service according to the first smart contract. Therefore, when the user wants to obtain a service, in other words, when the user wants to perform a transaction (for example, a transfer transaction), the user may send the registration request to the management network element, to obtain the first smart contract. When network resources are idle, the user may obtain the first smart contract from the management network element via the communication device, to avoid contending for radio resources with another user. In this way, deterioration of overall performance of a network is avoided.

The registration request may include the service request information. The service request information may be specific service information (business) that the communication device needs to obtain, for example, a data backup business, a big data analysis business, a traffic statistics business, and the like. It may be understood that the user may send a plurality of different registration requests to the management network element via the communication device, to request different services (businesses).

402: The management network element determines the first smart contract based on the service request information in the registration request.

The management network element is mainly responsible for blockchain management, root contract management, and the like in the CONET. Therefore, the root contract (namely, a contract template) of each blockchain in the CONET may be locally configured and stored in the management network element in advance, to provide a service for the user. In addition, the management network element stores a mapping relationship between the root contract and the service information. One specific service corresponds to one specific root contract. Therefore, after receiving the registration request from the communication device, the management network element may first determine, based on the service request information included in the registration request, a specific service requested by the communication device. Then, the management network element may locally find a first smart contract corresponding to the service. The first smart contract may include field information, and the field information may include change information. The field information may be a field of the first smart contract, and the change information may be a value of the field of the first smart contract. In other words, the first smart contract may declare only a field (namely, the field information) of the smart contract, and leave a value (namely, the change information) of the field null.

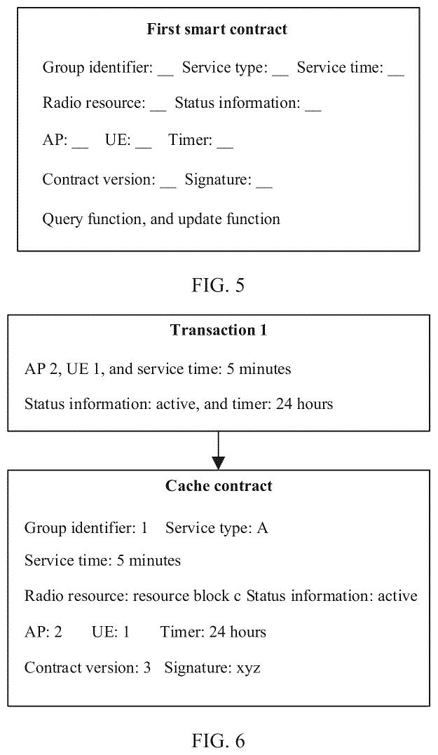

FIG. 5 is a schematic diagram of a first smart contract according to an embodiment of the present invention. The first smart contract shown in FIG. 5 may be a first smart contract (root contract) of a database side chain. The database side chain provides database-related functions, such as data storage, data reading, data backup, and the like. As shown in FIG. 5, the first smart contract may include field information, and the field information may include change information. To be specific, the first smart contract may include one or more contract fields (namely, the field information), for example, a group identifier (group ID), a service type (type), service time (time), a radio resource (resource), status (status) information, an access point (AP) identifier, a user equipment (UE) identifier, a timer (Timer), a contract version (version), a signature (signature), and the like. A value (namely, the change information) of each contract field is null (null). Therefore, storage costs of the communication device (blockchain node) may be reduced during deployment of the first smart contract. In addition, the first smart contract may further include one or more functional functions, for example, a query function (Query). A root contract of another blockchain in the CONET may be found based on the query function, so that the root contract of the another blockchain may be queried and invoked by the user when needed. The first smart contract may further include an update function (Update). The update function is used to provide an update interface of the smart contract for the user, to update the smart contract. It should be understood that the first smart contract shown in FIG. 5 is merely an example for description, and does not constitute a limitation on the first smart contract.

Communication devices have different compilation capabilities. To be specific, some communication devices may not have compilation capabilities, and some communication devices may have weak compilation capabilities. High time costs are needed for compiling the first smart contract. Therefore, the management network element may further compile the first smart contract, including compiling the functional function and the like in the first smart contract, to obtain a first compilation result (for example, machine code).

In addition, to facilitate management of each blockchain in the CONET, the management network element may use each blockchain as one group, and use a node in each blockchain as one member in the group. Each group (blockchain) may be identified based on a group ID. The group ID may be a numerical number set by the management network element. Each communication device (member in the group) may also have an ID to identify the communication device. The ID of the communication device may be an international mobile subscriber identity (international mobile subscriber identifier, IMSI). Therefore, the management network element may determine, based on the service request information, the specific service requested by the communication device, and then allocate the communication device to a group (blockchain) corresponding to the service. In addition, a group ID of the communication device may be determined.

403: The management network element sends the first smart contract to the communication device.

After determining the first smart contract based on the service request information in the registration request, the management network element may send the first smart contract to the communication device. Correspondingly, the communication device may receive the first smart contract from the management network element. When radio resources are idle, the management network element may send the first smart contract to the communication device, to improve radio resource utilization. In addition, contending for radio resources with another user may be avoided when allocable radio resources are insufficient. In this way, deterioration of the overall performance of the network is avoided, and network experience of the user may be improved. In addition, the first smart contract is not a complete contract, and the value of the field of the first smart contract is null. Therefore, complete transmission of the smart contract may be avoided, to save transmission resources. In addition, because an amount of transmitted information is reduced, a transmission period needed for transmitting the first smart contract may be reduced.

After the communication device receives the first smart contract from the management network element, when the user needs to obtain the service corresponding to the first smart contract, the communication device may be used to update, based on the specific service (business), the change information of the first smart contract. The first smart contract may be compiled, including compilation of a functional function in the root contract, to obtain a compilation result. Then, the communication device may execute the compilation result to obtain the corresponding service. For example, a compilation result corresponding to a query function (Query) is executed, to query a root contract of another blockchain in the CONET. This helps invoke the root contract of the another blockchain. For another example, the user needs to perform the transfer transaction. It is assumed that field information included in a first smart contract corresponding to a transfer business includes a transfer initiator ID, a transfer acceptor ID, transfer time, a transfer amount, and the like. The communication device may initiate an actual transfer transaction request (for example, transferring 10 from A to B) based on the first smart contract, update change information (namely, a value of a field of the first smart contract) of the first smart contract, and perform compilation on the first smart contract to obtain a corresponding service. For example, when initiating the transfer transaction request (for example, transferring 10 from A to B), the user A may update the change information of the first smart contract (to be specific, fill/change a value of a field necessary for running the first smart contract). For example, the transfer initiator ID is A, the transfer acceptor ID is B, the transfer time is current time, and the transfer amount is 10. Then, a compilation result of the first smart contract may be executed based on the value of the field (where logic of the transfer business is defined), and that transferring 10 from A to B is performed.

After obtaining the first compilation result (for example, the machine code), the management network element may send the first compilation result to the communication device. Correspondingly, the communication device may receive the first compilation result from the management network element. The first compilation result is a compilation result corresponding to the first smart contract. Then, when the user needs to obtain the service corresponding to the first smart contract, the communication device may directly run, based on the first compilation result sent by the management network element, the smart contract, to obtain the corresponding service. The communication device does not need to perform compilation, so that compilation time of the first smart contract may be reduced.

After determining the group ID of the communication device, the management network element may send the group ID to the communication device. Correspondingly, the communication device may receive the group ID from the management network element. The communication device receives the group ID from the management network element. It indicates that the communication device joins the corresponding group (blockchain), and then may use the first smart contract deployed on the blockchain.

After receiving the first smart contract from the management network element, the communication device may further store the first smart contract in a manner of a key-value pair, and determine a key-value pair corresponding to the first smart contract, to obtain key-value pair information. For example, the first smart contract (root contract) shown in FIG. 5 may be stored as {groupID: null, type: null, time: null, resource: null, status: null, AP: null, UE: null, Timer: null, version: null, signature: null}. Alternatively, the group ID may be used as a key or a specific key is generated, and content of the entire first smart contract is stored as a corresponding value. Then, the corresponding value (the content of the first smart contract) may be obtained based on a value of the key. The communication device may completely store the first smart contract in the manner of the key-value pair, and the key-value pair information (to be specific, the key for storing the first smart contract and the corresponding value) includes information about the first smart contract. In other words, the key-value pair information includes the complete content of the first smart contract. In addition, the stored first smart contract is not a complete contract, and the value of the field of the first smart contract is null. Therefore, storage resources of the communication device may be saved. After storing the first smart contract in the manner of the key-value pair, the communication device may send the key-value pair information to the management network element. In other words, the communication device sends, to the management network element, the key-value pair information for storing the first smart contract. Correspondingly, the management network element may receive the key-value pair information from the communication device. In addition, the communication device may further send the key-value pair information of the first smart contract to another node in the blockchain to which the first smart contract belongs. Correspondingly, the another node in the blockchain to which the first smart contract belongs may receive the key-value pair information from the communication device.

After receiving the key-value pair information from the communication device, the management network element may verify the information that is about the first smart contract and that is included in the key-value pair information (in other words, perform consensus on the content of the first smart contract). After the management network element reaches the consensus, the communication device only needs to fill, based on the first smart contract, a changed part of the contract content for use each time user service application is performed (when a transaction is generated), so that the communicate device can use a first smart contract. In addition, after receiving the key-value pair information from the communication device, the another node in the blockchain to which the first smart contract belongs may also verify the information that is about the first smart contract and that is included in the key-value pair information.

When the communication device receives the first smart contract from the management network element, and a service needed by the user is updated or changed, the user may send an update request to the management network element via the communication device. Correspondingly, the management network element may receive the update request from the communication device. The update request includes update information and the information about the first smart contract. The update information may be changed information of the first smart contract, for example, changed information of a value of a field of the first smart contract. The information about the first smart contract may be a group ID, or may be an ID or a name of the first smart contract. It may be understood that one or more first smart contracts (root contracts) included in the CONET may be distinguished based on IDs or names. In other words, the IDs and the names are in one-to-one correspondence with the first smart contracts. The update request initiated by the user may also carry an identifier number or a name of a smart contract, to specify a specific smart contract in the CONET.

For example, when the user needs a data backup service, a null field of a corresponding first smart contract may be filled based on an update request, to change a value of the field of the first smart contract, as shown in FIG. 6.

FIG. 6 is a schematic diagram of use of a first smart contract according to an embodiment of the present invention. As shown in FIG. 6, the communication device may receive a service request of the user, that is, a transaction (transaction) 1. The service request may be the data backup service request (which is used to back up local data to a cloud database). The transaction 1 may include an AP identifier, a UE identifier, service time, status information, a timer, and the like. The communication device may fill, based on content of the transaction 1, the first smart contract shown in FIG. 5, to obtain a cache contract (Cache Contract). For example, an ID of a group providing the data backup service may be 1. A service type corresponding to the data backup service may be A. Data backup time (that is, the service time) may be 5 minutes (min). Data backup radio resources (for example, time-frequency resources) may be a resource block (block) c. A UE status may be an active (active) state. A UE identifier may be 1. An AP identifier may be 2. Time of a timer may be 24 hours (hour). A version of the first smart contract may be a version 3. A user signature maybe xyz. The filled first smart contract may be used by UE to upload, to the cloud database, local information that needs to be backed up, and the upload is performed once every 24 hours. To fill the first smart contract, the communication device may send an update request to the management network element. The update request includes information about the first smart contract and update information (a change of a value of a field of the first smart contract). Correspondingly, the management network element may receive the update request from the communication device.

The user may further send the update request to the management network element via the communication device when the needed data backup service is changed (that is, when a new transaction is generated). For example, the user needs to modify the timer of the data backup service to perform backup once every 48 hours. In this case, an update request to the management network element may be sent via the communication device, and update information included in the update request may be (24 hour→48 hour).

After the management network element receives the update request from the communication device, the management network element may determine, based on the information about the first smart contract, the first smart contract that currently needs to be updated. The management network element may verify an updated part of the first smart contract based on the update information of the first smart contract, and update change information of the first smart contract. Then, the management network element may compile updated first smart contract, to obtain a second compilation result.

After obtaining the second compilation result, the management network element may send the second compilation result to the communication device. Correspondingly, the communication device may receive the second compilation result from the management network element. Then, the communication device may update, based on the update information of the first smart contract, the first smart contract stored in the manner of the key-value pair. For example, the communication device may update the key-value pair information of the first smart contract that is stored in the manner of the key-value pair to {groupID: 1, type: A, time: 5min, resource: block c, status: active, AP: 2, UE: 1, Timer: 48 hour, version: 3, signature: xyz}. In addition, the communication device may directly execute the second compilation result to obtain the service (that is, the data backup business) during previous application. The communication device may further generate a new block based on a data backup service result, and add the block to a blockchain to which the block belongs after the consensus is reached. After updating the first smart contract stored in the manner of the key-value pair, to obtain updated key-value pair information, the communication device may send the updated key-value pair information to the management network element for verification (that is, performing consensus on content of the updated first smart contract). The communication device may send the updated key-value pair information to another node in the blockchain to which the first smart contract belongs for verification. After the consensus is reached, the communication device may pack the change information of the first smart contract into a block, and add the block to a blockchain to which the block belongs. In addition, only the change information of the first smart contract may be added to the blockchain after the consensus is reached, and is stored in the blockchain. Therefore, storage costs of each node in the blockchain can be reduced.

The management network element may deliver the first smart contract in advance, in other words, deploy the first smart contract on each blockchain node in advance. Then, the communication device only needs to directly fill a corresponding field for use each time user service application is performed. Therefore, service waiting time of the user may be reduced. In addition, the management network element may further deliver, to each blockchain node, the compilation result corresponding to the first smart contract, so that each node can directly use the compilation result. This avoids that each node in a blockchain network independently compiles the smart contract, and reduces compilation costs of each node. Therefore, this facilitates large-scale deployment of blockchain services.

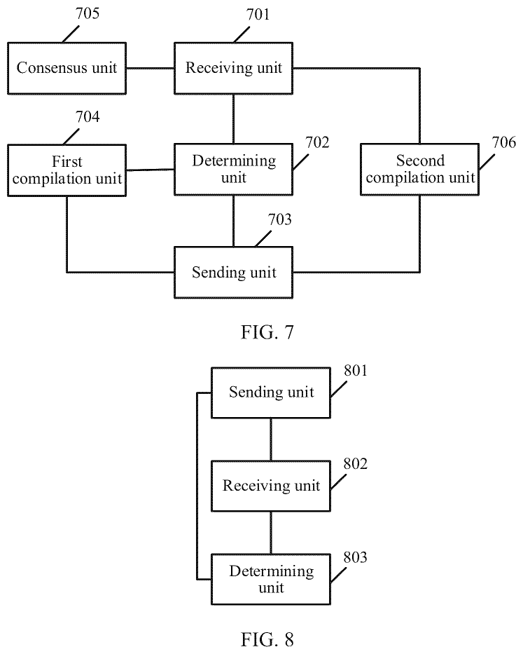

Based on the foregoing network architecture, FIG. 7 is a schematic diagram of a structure of a contract management apparatus according to an embodiment of the present invention. The contract management apparatus may be a management network element or a module in a management network element. As shown in FIG. 7, the contract management apparatus may include:
a receiving unit 701, configured to receive a registration request from a communication device, where the registration request includes service request information;
a determining unit 702, configured to determine a first smart contract based on the service request information; and
a sending unit 703, configured to send the first smart contract to the communication device.

In an embodiment, the contract management apparatus may further include:
a first compilation unit 704, configured to compile the first smart contract, to obtain a first compilation result.

The sending unit 703 is specifically configured to send the first smart contract and the first compilation result to the communication device.

In an embodiment, the determining unit 702 is further configured to determine a group identifier ID based on the service request information, where the group ID identifies a first blockchain, and the communication device is a node in the first blockchain; and
the sending unit 703 is further configured to send the group ID to the communication device.

In an embodiment, the receiving unit 701 is further configured to receive key-value pair information from the communication device, where the key-value pair information is information about a key-value pair corresponding to the first smart contract.

The contract management apparatus may further include:
a consensus unit 705, configured to perform consensus on the key-value pair information.

In an embodiment, the first smart contract includes field information, and the field information includes change information. The receiving unit is further configured to receive an update request from the communication device, where the update request includes update information and information about the first smart contract, and the update information is used to update the change information.

The contract management apparatus may further include:
a second compilation unit 706, configured to compile the first smart contract based on the update information, to obtain a second compilation result.

The sending unit 703 is further configured to send the second compilation result to the communication device.

The first compilation unit and the second compilation unit may be collectively referred to as compilation units.

For more detailed descriptions of the receiving unit 701, the determining unit 702, the sending unit 703, the first compilation unit 704, the consensus unit 705, and the second compilation unit 706, directly refer to related descriptions of the management network element in the method embodiment shown in FIG. 4. Details are not described herein.

Based on the foregoing network architecture, FIG. 8 is a schematic diagram of a structure of another contract management apparatus according to an embodiment of the present invention. The contract management apparatus may be a communication device or a module in a communication device. As shown in FIG. 8, the contract management apparatus may include:
a sending unit 801, configured to send, by the communication device, a registration request to a management network element, where the registration request includes service request information; and
a receiving unit 802, configured to receive a first smart contract from the management network element.

In an embodiment, that the receiving unit 802 receives the first smart contract from the management network element includes:
receiving the first smart contract and a first compilation result from the management network element.

In an embodiment, the receiving unit 802 is further configured to:
receive a group identifier ID from the management network element, where the group ID identifies a first blockchain, and the communication device is a node in the first blockchain.

In an embodiment, the contract management apparatus may further include:
a determining unit 803, configured to determine a key-value pair corresponding to the first smart contract, to obtain key-value pair information.

The sending unit 801 is further configured to send the key-value pair information to the management network element.

In an embodiment, the first smart contract includes field information, and the field information includes change information. The sending unit 801 is further configured to:
send an update request to the management network element, where the update request includes update information and information about the first smart contract, and the update information is used to update the change information.

The receiving unit 802 is further configured to receive a second compilation result from the management network element.

For more detailed descriptions of the sending unit 801, the receiving unit 802, and the determining unit 803, directly refer to related descriptions of the communication device in the method embodiment shown in FIG. 4. Details are not described herein.

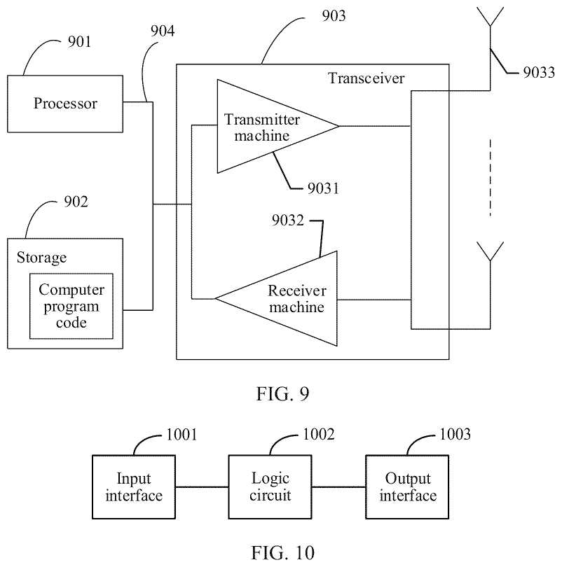

Based on the foregoing network architecture, FIG. 9 is a schematic diagram of a structure of still another contract management apparatus according to an embodiment of the present invention. As shown in FIG. 9, the contract management apparatus may include a processor 901, a storage 902, a transceiver 903, and a bus 904. The storage 902 may exist independently, and may be connected to the processor 901 through the bus 904. The storage 902 may alternatively be integrated with the processor 901. The bus 904 is configured to implement connections between these components. In a case, as shown in FIG. 9, the transceiver 903 may include a transmitter machine 9031, a receiver machine 9032, and an antenna 9033. In another case, the transceiver 903 may include a transmitter (that is, an output interface) and a receiver (that is, an input interface). The transmitter may include a transmitter machine and an antenna, and the receiver may include a receiver machine and an antenna.

In an embodiment, the contract management apparatus may be a management network element or a module (for example, a chip) in a management network element. When computer program instructions stored in the storage 902 are executed, the processor 901 is configured to control the sending unit 703 and the receiving unit 701 to perform operations performed in the foregoing embodiments. The processor is further configured to control the determining unit 702, the first compilation unit 704, the consensus unit 705, and the second compilation unit 706 to perform operations performed in the foregoing embodiments. The transceiver 903 is configured to perform operations performed by the sending unit 703 and the receiving unit 701 in the foregoing embodiments. The foregoing management network element or the module in the management network element may be further configured to perform the method performed by the management network element in the method embodiment in FIG. 4. Details are not described herein again.

In an embodiment, the contract management apparatus may be a communication device or a module (for example, a chip) in a communication device. When computer program instructions stored in the storage 902 are executed, the processor 901 is configured to control the sending unit 801 and the receiving unit 802 to perform operations performed in the foregoing embodiments. The processor is further configured to control the determining unit 803 to perform the operations performed in the foregoing embodiments. The transceiver 903 is configured to perform operations performed by the sending unit 801 and the receiving unit 802 in the foregoing embodiments. The communication device or the module in the communication device may be further configured to perform the method performed by the communication device in the method embodiment in FIG. 4. Details are not described herein again.

Based on the foregoing network architecture, FIG. 10 is a schematic diagram of a structure of yet another contract management apparatus according to an embodiment of the present invention. As shown in FIG. 10, the contract management apparatus may include an input interface 1001, a logic circuit 1002, and an output interface 1003. The input interface 1001 is connected to the output interface 1003 by using the logic circuit 1002. The input interface 1001 is configured to receive information from another contract management apparatus, and the output interface 1003 is configured to output, schedule, or send information to another contract management apparatus. The logic circuit 1002 is configured to perform an operation other than operations of the input interface 1001 and the output interface 1003, for example, implement a function implemented by the processor 901 in the foregoing embodiment. The contract management apparatus may be a management network element or a module in a management network element, or may be a communication device or a module in a communication device. For more detailed descriptions of the input interface 1001, the logic circuit 1002, and the output interface 1003, directly refer to related descriptions of the management network element or the communication device in the foregoing method embodiment. Details are not described herein.

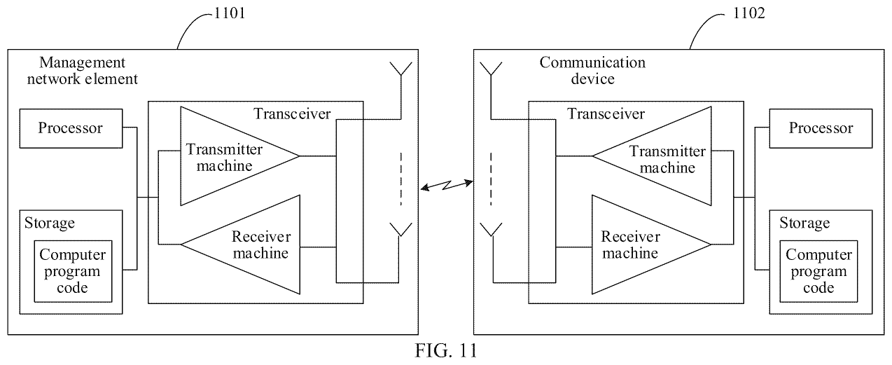

Based on the foregoing network architecture, FIG. 11 is a schematic diagram of a structure of a contract management system according to an embodiment of the present invention. As shown in FIG. 11, the contract management system may include a management network element 1101 and a communication device 1102. For detailed descriptions, refer to the contract management method shown in FIG. 4.

An embodiment of the present invention further discloses a computer-readable storage medium. The computer-readable storage medium stores instructions. When the instructions are executed, the method in the foregoing method embodiment is performed.

An embodiment of the present invention further discloses a computer program product including instructions. When the instructions are executed, the method in the foregoing method embodiment is performed.

In the foregoing specific implementations, the objectives, technical solutions, and beneficial effects of this application are further described in detail. It should be understood that, the foregoing descriptions are merely specific implementations of this application, but are not intended to limit the protection scope of this application. Any modification, equivalent replacement, improvement, or the like made based on the technical solutions of this application shall fall within the protection scope of this application.

What is claimed is:

1. A contract management method, comprising:
receiving, by a management network element, a registration request from a communication device, wherein the registration request comprises service request information;
determining a first smart contract based on the service request information; and
sending the first smart contract to the communication device.

2. The method according to claim 1, wherein the method further comprises:
compiling the first smart contract, to obtain a first compilation result; and
the sending the first smart contract to the communication device comprises:
sending the first smart contract and the first compilation result to the communication device.

3. The method according to claim 1, wherein the method further comprises:
determining a group identifier ID based on the service request information, wherein the group ID identifies a first blockchain, and the communication device is a node in the first blockchain; and
sending the group ID to the communication device.

4. The method according to claim 1, wherein the method further comprises:
receiving key-value pair information from the communication device, wherein the key-value pair information is information about a key-value pair corresponding to the first smart contract; and
performing consensus on the key-value pair information.

5. The method according to claim 1, wherein the first smart contract comprises field information, and the field information comprises change information; and the method further comprises:
receiving an update request from the communication device, wherein the update request comprises update information and information about the first smart contract, and the update information is used to update the change information;
compiling the first smart contract based on the update information, to obtain a second compilation result; and
sending the second compilation result to the communication device.

6. A contract management method, comprising:
sending, by a communication device, a registration request to a management network element, wherein the registration request comprises service request information; and
receiving a first smart contract from the management network element.

7. The method according to claim 6, wherein the receiving a first smart contract from the management network element comprises:
receiving the first smart contract and a first compilation result from the management network element.

8. The method according to claim 6, wherein the method further comprises:
receiving a group identifier ID from the management network element, wherein the group ID identifies a first blockchain, and the communication device is a node in the first blockchain.

9. The method according to claim 6, wherein the method further comprises:
determining a key-value pair corresponding to the first smart contract, to obtain key-value pair information; and
sending the key-value pair information to the management network element.

10. The method according to claim 6, wherein the first smart contract comprises field information, and the field information comprises change information; and the method further comprises:
sending an update request to the management network element, wherein the update request comprises update information and information about the first smart contract, and the update information is used to update the change information; and
receiving a second compilation result from the management network element.

11. A contract management apparatus, comprising: a processor and a transceiver, wherein the transceiver is configured to:
send a registration request to a management network element, wherein the registration request comprises service request information; and
receive a first smart contract from the management network element.

12. The apparatus according to claim 11, wherein the transceiver is configured to receive the first smart contract and a first compilation result from the management network element.

13. The apparatus according to claim 11, wherein the transceiver is further configured to receive a group identifier ID from the management network element, wherein the group ID identifies a first blockchain, and the communication device is a node in the first blockchain.

14. The apparatus according to claim 11, wherein the processor is configured to determine a key-value pair corresponding to the first smart contract, to obtain key-value pair information, wherein
the transceiver is further configured to send the key-value pair information to the management network element.

15. The apparatus according to claim 11, wherein the first smart contract comprises field information, and the field information comprises change information;
the sending unit is further configured to send an update request to the management network element, wherein the update request comprises update information and information about the first smart contract, and the update information is used to update the change information; and
the receiving unit is further configured to receive a second compilation result from the management network element.
